(19) United States
(12) Patent Application Publication
(10) Pub. No.: US 2026/0212337 A1
(43) Pub. Date: Jul. 23, 2026

(54) SYSTEM AND METHOD FOR INTEGRATING PAYMENT TERMINAL WITH POINT-OF-SALE SYSTEM

(71) Applicant: Mainintel Inc., Brampton (CA)

(72) Inventor: Pradeep Cheraputta KANOOR, Maharashtra (IN)

(21) Appl. No.: 19/452,427

(22) Filed: Jan. 19, 2026

(30) Foreign Application Priority Data
Jan. 17, 2025 (IN) 202541004060

(51) Int. Cl. G06Q 20/20; G06Q 20/40

(52) U.S. Cl. CPC G06Q 20/20; G06Q 20/40

(57) ABSTRACT

A method (500) for integrating a payment terminal (112) with a point-of-sale (POS) system (108) is provided. The method (500) includes extracting (502) invoice data from a rendered payment page executed in a browser application. The rendered payment page comprises one or more fields. The method (500) includes transmitting (504) invoice data to the payment terminal (112) over a Local Area Network for facilitating customer payment. The method (500) includes retrieving (506) transaction details from the payment terminal (112) in response to an event indicating customer payment. The method (500) includes updating (508) the one or more fields of the rendered payment page with transaction details through browser-level interaction. Extraction and retrieval are performed by a browser plugin configured to interface directly with the rendered payment page.

### CROSS-REFERENCE TO RELATED APPLICATIONS

This application claims priority to Indian Application No. 202541004060 titled SYSTEMS AND METHODS FOR INTEGRATING PAYMENT TERMINALS WITH POINT-OF-SALE (POS) SYSTEMS, filed on Jan. 17, 2025, which is hereby incorporated by reference in its entirety.

### FIELD OF INVENTION

The present disclosure relates to payment processing systems, and more particularly to a system and method for integrating a payment terminal with a point-of-sale system.

### BACKGROUND

With the advancement of technology, businesses such as car dealerships, clinics, supermarkets, merchant outlets, and various professional service providers are increasingly using Point-of-Sale (POS) systems to streamline transactions. These POS systems are implemented as computer-based applications or cloud-based browser applications for billing and invoice generation. In a typical transaction workflow, a clerk operating the POS system generates an invoice containing an invoice reference number and an invoice amount. The clerk then manually enters the invoice amount and optionally the invoice reference number on a standalone payment terminal before passing the terminal to a customer. The customer completes the payment at the payment terminal using various methods such as inserting or tapping a credit or debit card, or scanning a Quick Response (QR) code. Following a successful payment, the clerk generates a payment receipt and manually enters payment details, such as transaction identifiers and authorization codes, into the POS system to close the invoice.

Such conventional payment processes involve multiple manual data entry steps that can be time-consuming and prone to transposition errors. The manual transfer of information between the POS system and the payment terminal introduces opportunities for human error, which may result in discrepancies between invoice records and payment records. Additionally, the manual workflow requires the clerk to perform repetitive data entry tasks, which reduces operational efficiency and increases the time required to complete each transaction.

Some approaches to addressing these challenges involve using Application Programming Interfaces (APIs) to integrate payment terminals with POS systems. However, API-based integration processes can be expensive and complex to develop. Such integrations may require weeks or months of development effort and often need to be customized for each specific POS system across various business verticals. This creates a barrier for businesses seeking to streamline their payment workflows without undertaking extensive software development projects.

Therefore, there is a need to overcome one or more of above-mentioned limitations.

### SUMMARY

This summary is provided to introduce a selection of concepts, in a simplified format, that are further described in the detailed description of the invention. This summary is neither intended to identify key or essential inventive concepts of the invention nor is it intended for determining the scope of the invention.

According to an aspect of the present disclosure, a method for integrating a payment terminal with a point-of-sale (POS) system is provided. The method includes extracting invoice data associated with an invoice from a rendered payment page of the POS system. The rendered payment page is executed in a browser application. The rendered payment page includes one or more fields. The method includes transmitting the invoice data to the payment terminal over a Local Area Network (LAN) for facilitating a customer payment. The method includes retrieving one or more transaction details from the payment terminal in response to an event indicating the customer payment. The method includes updating the one or more fields of the rendered payment page of the POS system with the one or more transaction details through browser-level interaction with the rendered payment page. The extraction of the invoice data and the retrieval of the one or more transaction details are performed by a browser plugin configured to interface directly with the rendered payment page.

According to another aspect of the present disclosure, a system for integrating a payment terminal with a point-of-sale (POS) system is provided. The system includes a memory. The system includes at least one processor communicably connected to the memory. The at least one processor is configured to extract invoice data associated with an invoice from a rendered payment page of the POS system. The rendered payment page is executed in a browser application. The rendered payment page includes one or more fields. The at least one processor is configured to transmit the invoice data to the payment terminal over a Local Area Network (LAN) for facilitating a customer payment. The at least one processor is configured to retrieve one or more transaction details from the payment terminal in response to an event indicating the customer payment. The at least one processor is configured to update the one or more fields of the rendered payment page of the POS system with the one or more transaction details through browser-level interaction with the rendered payment page. The extraction of the invoice data and the retrieval of the one or more transaction details are performed by a browser plugin configured to interface directly with the rendered payment page.

To further clarify the advantages and features of the present invention, a more particular description of the invention will be rendered by reference to specific embodiments thereof, which are illustrated in the appended drawings. It is appreciated that these drawings depict only typical embodiments of the invention and are therefore not to be considered limiting of its scope. The invention will be described and explained with additional specificity and detail in the accompanying drawings.

### BRIEF DESCRIPTION OF FIGURES

These and other features, aspects, and advantages of the present invention will become better understood when the following detailed description is read with reference to the accompanying drawings in which like characters represent like parts throughout the drawings, wherein:

FIG. 1 illustrates an exemplary environment for implementing a system for integrating a payment terminal with a point-of-sale system, according to an embodiment of the present disclosure;

FIG. 2 illustrates a block diagram of the system for integrating the payment terminal with the point-of-sale system, according to an embodiment of the present disclosure;

FIG. 3 illustrates a process flow associated with an invoice data extraction sub-module of the system, according to an embodiment of the present disclosure;

FIG. 4 illustrates an exemplary scenario of integration between the payment terminal and the point-of-sale system, according to an embodiment of the present disclosure; and

FIG. 5 illustrates a flow chart depicting a method for integrating the payment terminal with the point-of-sale system, according to an embodiment of the present disclosure.

Further, skilled artisans will appreciate that elements in the drawings are illustrated for simplicity and may not have necessarily been drawn to scale. For example, the flow charts illustrate the method in terms of the most prominent steps involved to help to improve understanding of aspects of the present invention. Furthermore, in terms of the construction of the device, one or more components of the device may have been represented in the drawings by conventional symbols, and the drawings may show only those specific details that are pertinent to understanding the embodiments of the present invention so as not to obscure the drawings with details that will be readily apparent to those of ordinary skill in the art having the benefit of the description herein.

### DETAILED DESCRIPTION

For the purpose of promoting an understanding of the principles of the invention, reference will now be made to the various embodiments and specific language will be used to describe the same. It will nevertheless be understood that no limitation of the scope of the invention is thereby intended, such alterations and further modifications in the illustrated system, and such further applications of the principles of the invention as illustrated therein being contemplated as would normally occur to one skilled in the art to which the invention relates.

It will be understood by those skilled in the art that the foregoing general description and the following detailed description are explanatory of the invention and are not intended to be restrictive thereof.

Reference throughout this specification to “an aspect,” “another aspect” or similar language means that a particular feature, structure, or characteristic described in connection with the embodiment is included in at least one embodiment of the present invention. Thus, appearances of the phrase “in an embodiment,” “in another embodiment” and similar language throughout this specification may, but do not necessarily, all refer to the same embodiment.

The terms “comprises”, “comprising”, or any other variations thereof, are intended to cover a non-exclusive inclusion, such that a process or method that comprises a list of steps does not include only those steps but may include other steps not expressly listed or inherent to such process or method. Similarly, one or more devices or sub-systems or elements or structures or components proceeded by “comprises . . . a” does not, without more constraints, preclude the existence of other devices or other sub-systems or other elements or other structures or other components or additional devices or additional sub-systems or additional elements or additional structures or additional components.

Embodiments of the present invention will be described below in detail with reference to the accompanying drawings.

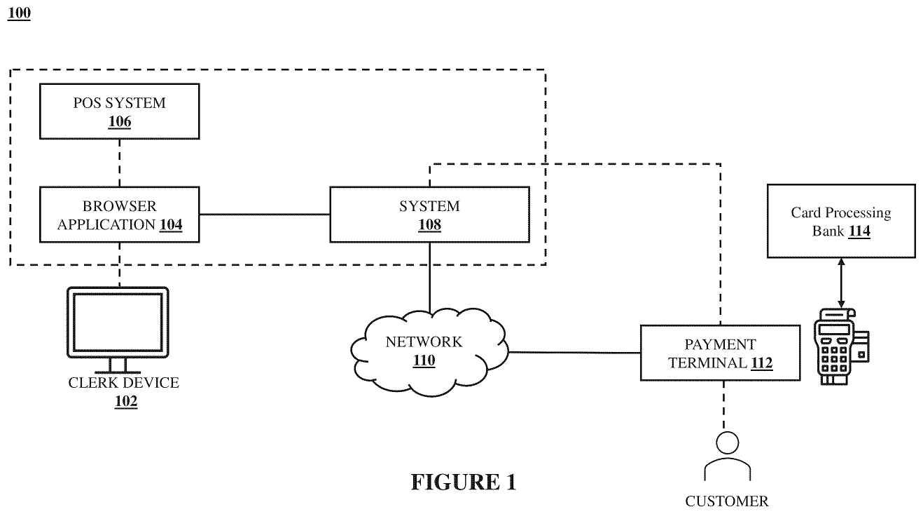

FIG. 1 illustrates an exemplary environment 100 for implementing a system 108 for integrating a payment terminal 112 with a point-of-sale (POS) system 106, according to an embodiment of the present disclosure.

The environment 100 may include a merchant organization. The merchant organization may include, but is not limited to, restaurants, retail establishments, professional services such as salons, clinics, car repair services, car dealerships, doctors offices, veterinarian offices, and dental offices. In some cases, the merchant organization may include other brick-and-mortar locations where customers make payments for goods or services.

The environment 100 depicts a network architecture designed to facilitate communication between payment processing components in the merchant organization setting. The system 108 may be configured to integrate the payment terminal 112 with the POS system 106 to address challenges associated with manual payment processing workflows. In some cases, the environment 100 may support multiple POS systems and multiple payment terminals based on a specific requirements of the merchant organization.

The environment 100 may include a clerk device 102. The clerk device 102 may be a user equipment operated by a clerk within the merchant organization. In some cases, the clerk device 102 may include, but is not limited to, a laptop computer, a desktop computer, a Personal Computer (PC), a tablet, or a smartphone. The clerk device 102 may include middleware installed therein with a database. The middleware may facilitate communication between components of the environment 100.

The clerk device 102 may have a browser application 104 installed therein. The browser application 104 may provide access to the POS system 106. In some cases, the browser application 104 may be a commercially available browser application. The browser application 104 may implement basic World Wide Web standards such as Hypertext Transfer Protocol (HTTP) and Hyper Text Markup Language (HTML). The browser application 104 may render payment pages associated with the POS system 106, allowing a clerk to generate invoices and process payments through the system 108.

The POS system 106 may be a cloud-based POS system. In some cases, the cloud-based POS system may be accessible through the browser application 104 installed on the clerk device 102. The cloud-based configuration may allow the POS system 106 to be accessed from various devices within the merchant organization without requiring local installation of dedicated software. In some cases, the POS system 106 may store invoice data, transaction records, and other business information on remote servers accessible via a network 110.

In some embodiment, the POS system 106 may be connected to the payment terminal 112. The POS system 106 may be a semi-integrated payment system. In the semi-integrated payment system, the payment terminal 112 may be a standalone secured device connected external to the POS system 106.

The network 110 may provide connectivity between the system 108 and the payment terminal 112. The network 110 may include a wireless network or a wired network. In some cases, the network 110 may correspond to cellular networks or mobile networks. The cellular networks may include third-generation (3G) networks, fourth-generation (4G) networks, fifth-generation (5G) networks, pre-5G networks, and sixth-generation (6G) networks. In some cases, the network 110 may include other wireless communication networks. The other wireless communication networks may include a Wireless fidelity (Wi-Fi) connection, a Near-Field Communication (NFC) connection, or a Bluetooth connection. The network 110 may facilitate data transmission between the system 108 installed on the clerk device 102 and the payment terminal 112, allowing invoice data to be transmitted from the POS system 106 to the payment terminal 112 and transaction details to be transmitted from the payment terminal 112 back to the system 108.

The payment terminal 112 may be a standalone device installed on a local area network (LAN) of the environment 100. The LAN installation may allow the payment terminal 112 to communicate with the system 108 and other components within the merchant organization without requiring external network connectivity for local data transmission. In some cases, the payment terminal 112 may be positioned in a customer-facing orientation to facilitate payment transactions.

The payment terminal 112 may be configured to accept electronic payments from customers. The electronic payments may be made through credit cards or debit cards. In some cases, the payment terminal 112 may support card insertion for chip-based transactions. In some cases, the payment terminal 112 may support card swiping for magnetic stripe transactions. The payment terminal 112 may process payment authorization requests and receive authorization responses for card-based transactions directly connecting to a card processing bank 114.

The payment terminal 112 may be capable of contactless payments using Near-Field Communication (NFC) technology. The NFC technology may allow customers to complete payment transactions by tapping a contactless-enabled card or device near the payment terminal 112. In some cases, the payment terminal 112 may be capable of mobile wallet payments. The mobile wallet payments may allow customers to use digital wallet applications stored on smartphones or other mobile devices to complete transactions. In some cases, the payment terminal 112 may be capable of Quick Response (QR) code scanning for payments. The QR code scanning may allow customers to complete payment transactions by presenting a QR code displayed on a mobile device for scanning by the payment terminal 112.

The payment terminal 112 may be in communication with the card processing bank 114. The card processing bank 114 may handle processing of card-based transactions received from the payment terminal 112. The communication between the payment terminal 112 and the card processing bank 114 may enable authorization of payment transactions. In some cases, the communication between the payment terminal 112 and the card processing bank 114 may enable settlement of payment transactions. The card processing bank 114 may verify customer account information, check available funds or credit limits, and provide authorization codes for approved transactions. In some cases, multiple card processing banks may be utilized based on the type of payment card presented by the customer.

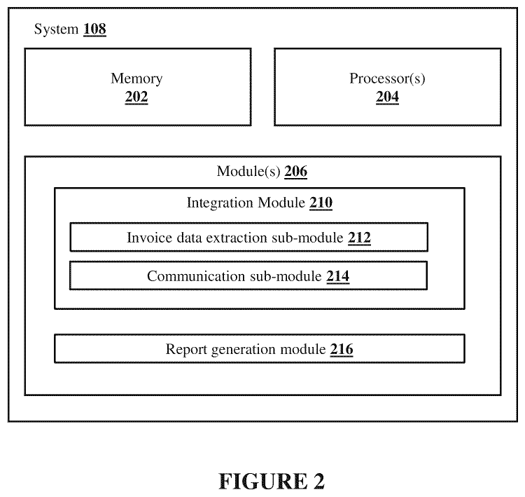

The construction and working of the system 108 is further described in detail in reference to FIGS. 2-4 .

FIG. 2 illustrates a block diagram of the system 108 for integrating the payment terminal 112 with the POS system 106, according to an embodiment of the present disclosure.

The system 108 may include a memory 202, at least one processor 204, and one or more modules 206. The memory 202, the at least one processor 204, and the one or more modules 206 may be communicatively coupled to enable integration functionality between the payment terminal 112 and the POS system 106.

The memory 202 may be communicatively coupled to the at least one processor 204. The memory 202 may be configured to store data and instructions executable by the at least one processor 204. In some cases, the memory 202 may communicate via a bus within the system 108. The memory 202 may include non-transitory computer-readable storage media. The non-transitory computer-readable storage media may include various types of volatile and non-volatile storage media. The volatile and non-volatile storage media may include, but are not limited to, random access memory, read-only memory, programmable read-only memory, electrically programmable read-only memory, electrically erasable read-only memory, flash memory, magnetic tape or disk, and optical media. In some cases, the memory 202 may include a cache or random-access memory for the at least one processor 204. In some cases, the memory 202 may be separate from the at least one processor 204, such as a cache memory of a processor, system memory, or other memory. The memory 202 may be an external storage device or database for storing data. The memory 202 may be operable to store instructions executable by the at least one processor 204. In some cases, the memory 202 may include a database to store data associated with invoice transactions and payment processing. The memory 202 may include an operating system for performing one or more tasks of the system 108.

The at least one processor 204 may be communicably connected to the memory 202. The at least one processor 204 may be operatively coupled to each of the memory 202 and the one or more modules 206. The at least one processor 204 may include specialized processing units. The specialized processing units may include integrated system controllers, memory management control units, floating point units, graphics processing units, and digital signal processing units. In some cases, the at least one processor 204 may include a Central Processing Unit (CPU), a Graphics Processing Unit (GPU), or both. The at least one processor 204 may be one or more general processors, Digital Signal Processors (DSPs), application-specific integrated circuits, Field-Programmable Gate Arrays (FPGAs), servers, networks, digital circuits, analog circuits, combinations thereof, or other devices for analyzing and processing data. The at least one processor 204 may execute a software program, such as code generated manually to perform desired operations. In some cases, the at least one processor 204 may implement various techniques such as data extraction, Artificial Intelligence (AI), Machine Learning (ML), and Deep Learning (DL) to achieve desired objectives.

The one or more modules 206 may include routines, programs, objects, components, and data structures that perform particular tasks or implement data types. The one or more modules 206 may be implemented as signal processors, state machines, logic circuitries, or other devices or components that manipulate signals based on operational instructions. The one or more modules 206 may be implemented in hardware, instructions executed by a processing unit, or by a combination thereof. The processing unit may comprise a computer, the at least one processor 204, a state machine, a logic array, or other suitable devices capable of processing instructions. In some cases, the one or more modules 206 may be machine-readable instructions which, when executed by a processor or processing unit, perform described functionalities associated with integrating the payment terminal 112 with the POS system 106.

The memory 202 may include non-transitory computer-readable storage media. The non-transitory computer-readable storage media may include random access memory. The non-transitory computer-readable storage media may include read-only memory. The non-transitory computer-readable storage media may include programmable read-only memory. The non-transitory computer-readable storage media may include electrically programmable read-only memory. The non-transitory computer-readable storage media may include electrically erasable read-only memory. The non-transitory computer-readable storage media may include flash memory. The non-transitory computer-readable storage media may include magnetic tape or disk. The non-transitory computer-readable storage media may include optical media. In some cases, the non-transitory computer-readable storage media may include combinations of the foregoing storage media types to provide both volatile and non-volatile storage capabilities for the system.

The processor 204 may include specialized processing units. The specialized processing units may include integrated system controllers. The integrated system controllers may also be referred to as bus controllers. The specialized processing units may include memory management control units. The specialized processing units may include floating point units. The specialized processing units may include graphics processing units. The specialized processing units may include digital signal processing units. In some cases, the processor 204 may include a Central Processing Unit (CPU). In some cases, the processor 204 may include a Graphics Processing Unit (GPU). In some cases, the processor 204 may include both a CPU and a GPU. The processor 204 may include Digital Signal Processors (DSPs). The processor 204 may include application-specific integrated circuits. The processor 204 may include Field-Programmable Gate Arrays (FPGAs). In some cases, the processor 204 may include combinations of the foregoing processing units to provide processing capabilities for various computational tasks.

The processor 204 may implement various techniques to achieve desired objectives. The processor 204 may implement data extraction techniques. The data extraction techniques may be used to identify and retrieve data from rendered web pages or other data sources. In some cases, the processor 204 may implement Artificial Intelligence (AI) techniques. The AI techniques may enable the processor 204 to perform tasks that involve pattern recognition or decision-making. In some cases, the processor 204 may implement Machine Learning (ML) techniques. The ML techniques may enable the processor 204 to learn from data and improve performance over time without explicit programming for each scenario. In some cases, the processor 204 may implement Deep Learning (DL) techniques. The DL techniques may enable the processor 204 to process complex data patterns using neural network architectures. The various techniques implemented by the processor 204 may be used individually or in combination to support operations associated with integrating payment terminals with point-of-sale systems.

The one or more modules 206 may include an integration module 210 and a report generation module 216. The integration module 210 may include an invoice data extraction sub-module 212 and a communication sub-module 214. These modules may operate cooperatively to facilitate integration between the payment terminal 112 and the POS system 106 without requiring modification to the underlying POS system 106 software. In some cases, the modules may be implemented as software components executable by the at least one processor 204, with associated data structures stored in the memory 202.

The integration module 210 may be configured to coordinate the overall integration functionality between the browser application 104 and the payment terminal 112. The integration module 210 may be implemented as a browser plugin capable of being installed in the browser application 104. The browser plugin configuration may allow the integration module 210 to interface directly with rendered payment pages of the POS system 106 without requiring backend API access to the POS system 106. In some cases, the browser plugin may be installed on the clerk device 102 and may operate within the browser application 104 to facilitate data exchange between the rendered payment pages and the payment terminal 112. The integration module 210 may be configured to update one or more fields of the rendered payment page of the POS system 106 with transaction details through browser-level interaction with the rendered payment page.

The integration module 210 may include an invoice data extraction sub-module 212. The invoice data extraction sub-module 212 may be configured to extract invoice data associated with an invoice from the rendered payment page of the POS system 106. The invoice data extraction sub-module 212 may identify and locate invoice data fields on the rendered payment page. In some cases, the invoice data extraction sub-module 212 may identify invoice data fields based on Hyper Text Markup Language (HTML) tags and attributes associated with elements of the rendered payment page. The invoice data extraction sub-module 212 may access a pre-configured lookup table stored in the memory 202 to determine which HTML tags and attributes correspond to specific invoice data fields such as invoice reference number fields and invoice amount fields.

The pre-configured lookup table may store associations between field types and corresponding HTML tags and attributes for a given POS system 106. Each POS system may have a different web page structure with different HTML tags and attributes. The HTML tags and attributes associated with invoice data fields on the rendered payment page may be static for a given POS system, allowing the invoice data extraction sub-module 212 to identify and locate the same fields on subsequent instances of the rendered payment page after an initial training process. The pre-configured lookup table may include entries for invoice reference number fields, invoice amount fields, currency type fields, tax detail fields, and line item detail fields, among others.

The invoice data extraction sub-module 212 may be pre-trained with invoice reference numbers and invoice amounts to retrieve invoice data from the payment page of the POS system 106. The pre-training may involve configuring the invoice data extraction sub-module 212 to recognize HTML tags and attributes associated with invoice data fields through a training process. In some cases, the training process may involve a clerk highlighting or selecting invoice data fields on the rendered payment page and the invoice data extraction sub-module 212 storing associated HTML tags and attributes in the lookup table. Alternatively, in another embodiment, the invoice data extraction sub-module 212 may utilize a pre-configured lookup table populated with HTML tag and attribute mappings without requiring a training process. The pre-configured lookup table may be provided as part of the installation package for the integration module 210, containing predefined mappings for commonly used POS systems.

During the training process, when a clerk highlights an invoice amount field on the rendered payment page, the invoice data extraction sub-module 212 may inspect the HTML structure of the highlighted element to identify its HTML tag, element identifier, class name, and other attributes. The invoice data extraction sub-module 212 may store these attributes in the lookup table along with an indication that they correspond to an invoice amount field. Similarly, when the clerk highlights an invoice reference number field, the invoice data extraction sub-module 212 may identify and store the HTML attributes associated with that field. Following completion of the training process for a given POS system, the stored HTML tags and attributes may be used by the invoice data extraction sub-module 212 to automatically identify and extract invoice data from subsequent instances of the rendered payment page.

The invoice data extraction sub-module 212 may be pre-trained with metadata to retrieve the metadata from the payment page of the POS system 106. The metadata may include a currency type, tax details, and details of line items of an invoice. The training process for metadata retrieval may follow a similar approach to the training for invoice data retrieval, where the clerk highlights metadata fields on the rendered payment page and the invoice data extraction sub-module 212 stores associated HTML tags and attributes in the lookup table. In some cases, the metadata may include optional fields such as store location numbers or tax identification numbers that may be extracted when present on the rendered payment page.

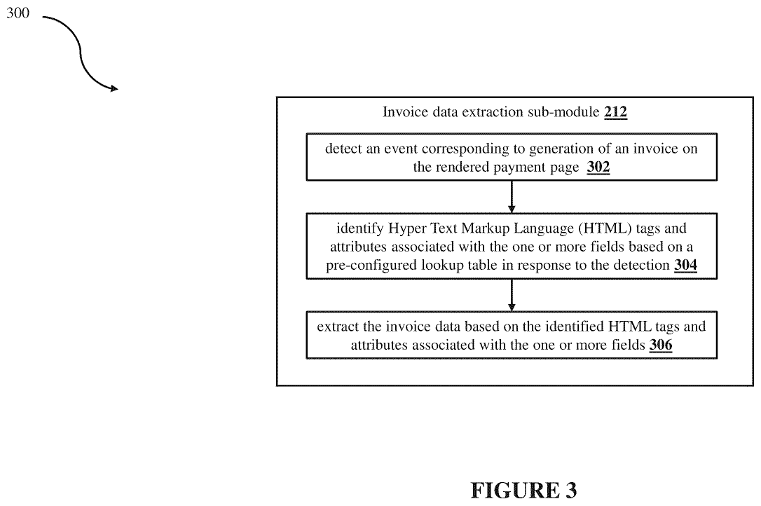

FIG. 3 illustrates a process flow 300 associated with the invoice data extraction sub-module 212 of the system 108, according to an embodiment of the present disclosure. The process flow 300 depicts the steps performed by the invoice data extraction sub-module 212 to extract invoice data from the rendered payment page of the POS system 106.

In an embodiment, the process flow 300, at step 302, includes detecting an event corresponding to generation of the invoice on the rendered payment page. The invoice data extraction sub-module 212 may monitor the rendered payment page to identify state changes indicating that an invoice has been created or is ready for payment processing. The event detection may be performed by monitoring changes to elements of the rendered payment page within the browser application 104. In some cases, the invoice data extraction sub-module 212 may monitor for the appearance of invoice data fields that indicate an invoice has been generated. The invoice data extraction sub-module 212 may detect the event by monitoring for specific URL changes, page navigation events, or element visibility changes associated with invoice generation within the POS system 106.

Thereafter, at step 304, the process flow 300 includes identifying HTML tags and attributes associated with the one or more fields based on a pre-configured lookup table in response to the detection. HTML tags may indicate markup elements that define the structure of web page content. Attributes associated with the one or more fields may be properties added to HTML tags to define characteristics, behaviors, or identifiers of elements. Upon detecting the invoice generation event, the invoice data extraction sub-module 212 may access the pre-configured lookup table stored in the memory 202. The pre-configured lookup table may store associations between field types and corresponding HTML tags and attributes for the POS system 106 being used. The invoice data extraction sub-module 212 may retrieve the HTML tags and attributes associated with invoice data fields such as invoice reference number fields and invoice amount fields from the lookup table. The invoice data extraction sub-module 212 may scan the HTML structure of the rendered payment page to locate elements matching the stored HTML tags and attributes.

Subsequently, at step 306, the process flow 300 includes extracting the invoice data based on the identified HTML tags and attributes associated with the one or more fields. Upon locating elements matching the stored HTML tags and attributes, the invoice data extraction sub-module 212 may read values contained within the identified elements. For example, when an invoice amount field is identified, the invoice data extraction sub-module 212 may access the HTML element corresponding to that field and may read the value contained within the element. Similarly, when an invoice reference number field is identified, the invoice data extraction sub-module 212 may read the value from that element. The extracted invoice data may include the invoice amount, the invoice reference number, and any metadata fields identified based on the pre-configured lookup table. The extracted invoice data may be provided to the communication sub-module 214 for transmission to the payment terminal 112.

In an embodiment, the integration module 210 may include a communication sub-module 214. The communication sub-module 214 may be configured to transmit invoice data to the payment terminal 112 and to retrieve transaction details from the payment terminal 112. The communication sub-module 214 may establish communication with the payment terminal 112 over the local area network 110. The local area network-based communication may enable low-latency data transmission between the integration module 210 installed on the clerk device 102 and the payment terminal 112 within the merchant organization. In some cases, the communication sub-module 214 may establish a communication session with the payment terminal 112 when the integration module 210 is initialized, and may maintain the communication session for subsequent data transmissions.

Upon receiving invoice data from the invoice data extraction sub-module 212, the communication sub-module 214 may transmit the invoice data to the payment terminal 112 using various transmission techniques. The transmission technique may be selected based on the network configuration of the merchant organization, the capabilities of the payment terminal 112, and the communication protocols supported by the payment terminal 112. In some cases, the transmission technique may be configured during initial setup of the integration module 210 and may remain consistent for subsequent invoice data transmissions within the merchant organization.

The communication sub-module 214 may transmit the invoice data using a Hypertext Transfer Protocol (HTTP) post transmission for local LAN communication. The HTTP post transmission may involve the communication sub-module 214 sending an HTTP request containing the invoice data to an endpoint associated with the payment terminal 112. The endpoint may be identified by an Internet Protocol (IP) address or hostname of the payment terminal 112 on the local area network 110. The HTTP post transmission may include the invoice data formatted as a request body in a structured format such as JavaScript Object Notation (JSON) or form-encoded data. The payment terminal 112 may receive the HTTP post request, parse the invoice data from the request body, and display the invoice amount and invoice reference number on a payment terminal display for customer verification.

Alternatively, the communication sub-module 214 may transmit the invoice data using a socket-based connection for transmitting an Extensible Markup Language (XML) packet. The socket-based connection may establish a direct communication channel between the communication sub-module 214 and the payment terminal 112 over the local area network 110. The socket-based connection may utilize Transmission Control Protocol (TCP) sockets to provide reliable, ordered delivery of data. The socket-based connection may be established when the communication sub-module 214 is initialized and may remain open for subsequent invoice data transmissions. The XML packet may contain the invoice data structured according to a predefined schema recognized by the payment terminal 112. The XML packet may include elements for the invoice amount, the invoice reference number, and metadata such as currency type and tax details. The payment terminal 112 may receive the XML packet through the socket-based connection, parse the XML elements, and extract the invoice data for display and transaction processing.

In another embodiment, the communication sub-module 214 may transmit the invoice data using a Message Queuing Telemetry Transport (MQTT) message broker transmission for cloud-based connection via a Wide Area Network (WAN). The MQTT protocol may be a lightweight publish-subscribe messaging protocol designed for constrained devices and low-bandwidth, high-latency networks. The communication sub-module 214 may publish the invoice data as a message to an MQTT message broker. The payment terminal 112 may subscribe to a topic associated with invoice data messages and may receive the published message from the MQTT message broker. The MQTT message broker may facilitate asynchronous communication between the communication sub-module 214 and the payment terminal 112, allowing the invoice data to be transmitted even when the payment terminal 112 is temporarily unavailable or when network conditions vary.

Following transmission of the invoice data to the payment terminal 112, the communication sub-module 214 may retrieve transaction details from the payment terminal 112 in response to an event indicating completion of a customer payment. The event may be generated by the payment terminal 112 upon successful authorization of a payment transaction or upon decline of a payment transaction. The transaction details may include a transaction identifier and an authorization code. In some cases, the transaction details may include additional information such as payment status, timestamp, card type information, and card brand associated with the payment method.

The communication sub-module 214 may retrieve the transaction details using various technical mechanisms corresponding to the transmission technique used for invoice data transmission. The communication sub-module 214 may receive the transaction details via same session transmission, where the payment terminal 112 transmits the transaction details through the same communication session established for transmitting the invoice data.

Alternatively, the communication sub-module 214 may receive the transaction details via a callback technique. The callback technique may involve the payment terminal 112 initiating a communication to the communication sub-module 214 upon completion of the payment transaction. The communication sub-module 214 may register a callback endpoint or listener during the invoice data transmission process. The payment terminal 112 may store the callback endpoint information and may transmit the transaction details to the callback endpoint upon completion of the payment transaction. The callback technique may allow the communication sub-module 214 to receive transaction details asynchronously without maintaining an active connection to the payment terminal 112 during the payment processing period.

In the case of MQTT transmission, the communication sub-module 214 may receive the transaction details via a cloud-based message broker. The payment terminal 112 after processing and generating a receipt may publish the transaction details as a message to the cloud-based message broker upon completion of the payment transaction. The communication sub-module 214 may subscribe to a topic associated with transaction response messages and may receive the published message from the cloud-based message broker. The cloud-based message broker may facilitate asynchronous communication between the payment terminal 112 and the communication sub-module 214.

The communication sub-module 214 may wait for a response from the payment terminal 112 based on a timeout setting. The timeout setting may define a timeout period during which the communication sub-module 214 awaits receipt of the transaction details from the payment terminal 112. In some example embodiments, the timeout period may range from 30 seconds to 2 minutes. In some cases, the timeout period may be configured based on expected payment processing times for the merchant organization. Upon expiration of the timeout period without receipt of the transaction details, the communication sub-module 214 may generate a timeout notification indicating that the payment transaction response was not received within the expected time period. In case of a timeout exception, processing will take place to reverse the incomplete transactions if any occurred.

The communication sub-module 214 may use a secondary polling mechanism where the communication sub-module 214 keeps polling the payment terminal 112 every predefined time period, for instance, 5 seconds for transaction status. The secondary polling mechanism may provide an alternative mechanism for retrieving the transaction details when a primary response mechanism does not deliver the transaction details within the expected time period. The secondary polling mechanism may involve the communication sub-module 214 periodically sending status inquiry requests to the payment terminal 112 at the predefined time interval. Each status inquiry request may query the payment terminal 112 for the current status of the payment transaction and any available transaction details. When the payment transaction is still in progress, the payment terminal 112 may respond with a pending status indication. When the payment transaction has been completed, the payment terminal 112 may respond with the transaction details including the transaction identifier and the authorization code. The communication sub-module 214 may continue polling the payment terminal 112 until the transaction details are received or until the pre-defined time period expires.

Upon receiving the transaction details from the payment terminal 112, the communication sub-module 214 may provide the transaction details to the integration module 210 for updating the rendered payment page. The communication sub-module 214 may also provide the transaction details to the report generation module 216 for inclusion in transaction reports. In some cases, the communication sub-module 214 may be configured to display a payment status on the clerk device 102. The payment status may indicate whether the payment transaction was approved or declined by a card processing bank 114. The payment status may be displayed within a plugin interface rendered in the browser application 104 on the clerk device 102 as a visual indicator such as a text message, a color-coded notification, or an icon representing the approval or decline status.

Referring again to FIG. 2, the report generation module 216 may be configured to generate reports of customer transactions at predefined time intervals or for custom timeframes. The report generation module 216 may collect transaction data throughout a business day, including invoice amounts, invoice reference numbers, transaction identifiers, authorization codes, and timestamps associated with each customer transaction processed through the integration module 210. The collected transaction data may be stored in the memory 202 as individual transaction records.

At the end of each business day, the report generation module 216 may automatically generate a report aggregating all transaction data collected during that day. The predefined time interval for report generation may correspond to end of business day periods, where the report is generated at the conclusion of each business day. In some cases, the predefined time interval may correspond to other periodic intervals such as hourly intervals, shift intervals, or weekly intervals based on the operational requirements of the merchant organization. The report generation module 216 may be configured to generate the report automatically at the predefined time interval without requiring manual initiation by a clerk.

The report generation module 216 may also be configured to generate reports for custom timeframes specified by a clerk or administrator of the merchant organization. The custom timeframe may span multiple business days, allowing the merchant organization to generate weekly, monthly, or quarterly transaction reports. In some cases, the custom timeframe may cover a portion of a single business day, allowing the merchant organization to generate reports for specific shifts or time periods within a day. The custom timeframe capability may provide flexibility for the merchant organization to generate transaction reports aligned with accounting periods, audit requirements, or management reporting schedules.

The integration module 210 may be further configured to generate an electronic copy of a payment receipt upon completion of a payment transaction at the payment terminal 112. The electronic copy of the payment receipt may include transaction information such as the invoice amount, the invoice reference number, the transaction identifier, the authorization code, and a timestamp indicating when the payment transaction was processed. In some cases, the electronic copy may include merchant organization information such as a business name, address, and contact information. The electronic copy may include customer-facing information such as the last four digits of a payment card number and the card brand associated with the payment method.

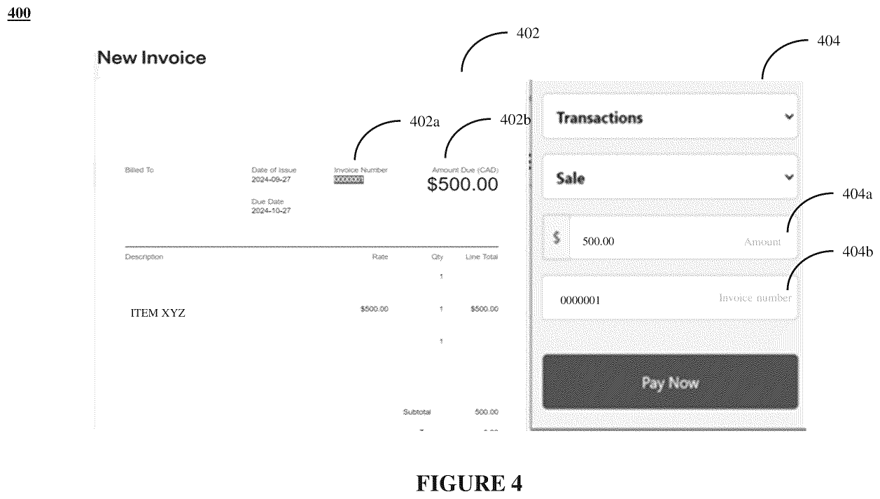

FIG. 4 illustrates an exemplary scenario 400 of integration between the payment terminal 112 and the POS system 106, according to an embodiment of the present disclosure.

As shown in the figure, the clerk generates an invoice on the payment page 402 of the POS system 106, where the invoice amount is $500.00 and the invoice reference number is 0000001, as shown in fields 402a and 402b respectively of the payment page 402. The system 108 extracts the invoice amount and the invoice reference number from the fields 402a and 402b and transmits the extracted invoice data to the payment terminal 112. The extracted data is displayed to the customer on the display of the payment terminal 112, allowing the customer to make the payment. For example, the invoice amount is displayed in field 404a and the invoice reference number is shown in field 406a.

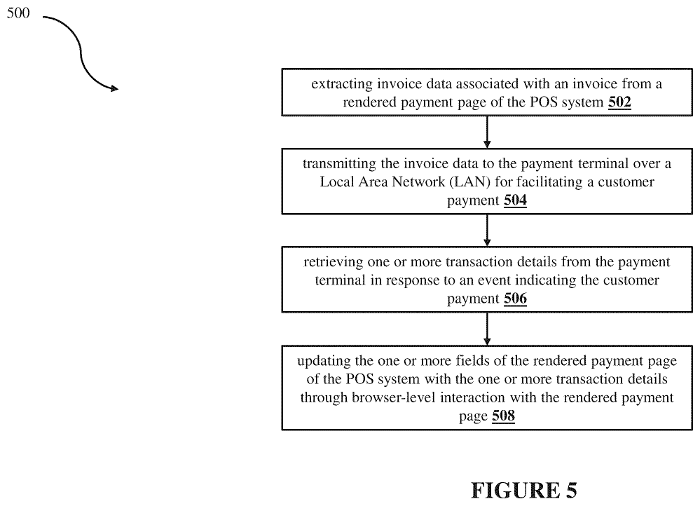

FIG. 5 illustrates a flow chart depicting a method 500 for integrating the payment terminal 112 with the POS system 106, according to an embodiment of the present disclosure. The method 500 may be a computer-implemented method executed by the integration module 210, the invoice data extraction sub-module 212, and the communication sub-module 214 of the system 108. For the sake of brevity, constructional and operational features of the system 108 that are already explained in the description of FIGS. 1-4 are not explained in detail in the description of FIG. 5.

The method 500, at step 502, involves extracting invoice data associated with an invoice from a rendered payment page of the POS system 106 executing in a browser application. The rendered payment page includes the one or more fields. The extracting of the invoice data is performed by the browser plugin configured to interface directly with the rendered payment page.

Thereafter, at step 504, the method 500 involves transmitting the invoice data to the payment terminal 112 over the LAN for facilitating a customer payment.

Subsequently, at step 506, the method 500 involves retrieving the one or more transaction details from the payment terminal 112 in response to the event indicating the customer payment. The retrieval of the one or more transaction details is performed by the browser plugin configured to interface directly with the rendered payment page.

Following this, at step 508, the method 500 involves updating the one or more fields of the rendered payment page of the POS system 106 with the one or more transaction details through browser-level interaction with the rendered payment page. The updating integrates the payment terminal 112 with the POS system 106.

At least by virtue of the aforesaid, the present subject matter at least provides the following advantages:
The present disclosure herein provides integration between payment terminal devices and point-of-sale systems through browser-level interaction with rendered payment pages, thereby eliminating the need for Application Programming Interface (API) development or modification to underlying POS system software.

The present disclosure herein automates bidirectional data transfer between the POS system and the payment terminal device by extracting invoice data from the rendered payment page and populating transaction details back into the rendered payment page, thereby eliminating manual data entry steps that are prone to transposition errors and digit omission errors.

The present disclosure herein utilizes a pre-configured lookup table storing HTML tags and attributes associated with invoice data fields, thereby enabling automatic field identification across different POS system interfaces following a one-time training process.

The present disclosure herein reduces integration implementation time from weeks or months associated with API-based integration to minutes associated with configuring the pre-configured lookup table through a training process, thereby significantly accelerating deployment of payment terminal integration.

The present disclosure herein transmits invoice data to the payment terminal device over a local area network, thereby providing low-latency communication that reduces wait times during payment processing and ensures reliable data transmission without external network dependencies.

The present disclosure herein eliminates the need for clerk intervention in transferring invoice amounts and invoice reference numbers to the payment terminal device and in transferring transaction identifiers and authorization codes back to the POS system, thereby reducing manual effort.

The present disclosure herein operates without requiring backend system access, administrative credentials, or server-side software installation, thereby providing deployment flexibility through standard browser extension installation mechanisms on clerk devices.

The present disclosure herein maintains functionality despite changes to underlying POS system architecture by operating at the presentation layer of rendered payment pages, thereby reducing maintenance requirements.

While specific language has been used to describe the disclosure, any limitations arising on account of the same are not intended. As would be apparent to a person in the art, various working modifications may be made to the method in order to implement the inventive concept as taught herein.

The drawings and the forgoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, orders of processes described herein may be changed and are not limited to the manner described herein.

We claim:

1. A method (500) for integrating a payment terminal (112) with a point-of-sale (POS) system (106), the method (500) comprising:
extracting (502) invoice data associated with an invoice from a rendered payment page of the POS system (106), the rendered payment page being executed in a browser application (104), wherein the rendered payment page comprises one or more fields, wherein extracting the invoice data comprises;
transmitting (504) the invoice data to the payment terminal (112) over a Local Area Network (LAN) for facilitating a customer payment;
retrieving (506) one or more transaction details from the payment terminal (112) in response to an event indicating the customer payment; and
updating (508) the one or more fields of the rendered payment page of the POS system (106) with the one or more transaction details through browser-level interaction with the rendered payment page,
wherein the extraction of the invoice data and the retrieval of the one or more transaction details are performed by a browser plugin configured to interface directly with the rendered payment page.

2. The method (500) as claimed in claim 1, wherein the invoice data comprises one or more of an invoice amount, an invoice reference number, and metadata associated with the invoice.

3. The method (500) as claimed in claim 2, wherein the metadata comprises one or more of a currency type, tax details, and details of line items of the invoice.

4. The method (500) as claimed in claim 1, wherein the one or more transaction details comprise at least one of a transaction identifier and an authorization code.

5. The method (500) as claimed in claim 1, wherein extracting (502) the invoice data comprises:
detecting an event corresponding to generation of an invoice on the rendered payment page;
identifying Hyper Text Markup Language (HTML) tags and attributes associated with the one or more fields based on a pre-configured lookup table in response to the detection; and
extracting the invoice data based on the identified HTML tags and attributes associated with the one or more fields.

6. The method (500) as claimed in claim 1, wherein transmitting (504) the invoice data to the payment terminal (112) comprises transmitting the invoice data using one of a Hypertext Transfer Protocol (HTTP) post transmission, a socket-based connection for transmitting an Extensible Markup Language (XML) packet, or a Message Queuing Telemetry Transport (MQTT) message broker transmission.

7. The method (500) as claimed in claim 1, further comprises generating a report of a plurality of customer transactions at a pre-defined time interval.

8. A system (108) for integrating a payment terminal (112) with a point-of-sale (POS) system (106), the system (108) comprising:
a memory (202); and
at least one processor (204) communicably connected to the memory (202), the at least one processor (204) configured to:
extract invoice data associated with an invoice from a rendered payment page (302) of the POS system (106), the rendered payment page being executed in a browser application (104), wherein the rendered payment page comprises one or more fields;
transmit the invoice data to the payment terminal (112) over a Local Area Network (LAN) for facilitating a customer payment;
retrieve one or more transaction details from the payment terminal (112) in response to an event indicating the customer payment; and
update the one or more fields of the rendered payment page of the POS system (106) with the one or more transaction details through browser-level interaction with the rendered payment page,
wherein the extraction of the invoice data and the retrieval of the one or more transaction details are performed by a browser plugin configured to interface directly with the rendered payment page.

9. The system (108) as claimed in claim 8, wherein the invoice data comprises one or more of an invoice amount, an invoice reference number, and metadata associated with the invoice.

10. The system (108) as claimed in claim 9, wherein the metadata comprises one or more of a currency type, tax details, and details of line items of the invoice.

11. The system (108) as claimed in claim 8, wherein the one or more transaction details comprise at least one of a transaction identifier and an authorization code.

12. The system (108) as claimed in claim 8, wherein to extract the invoice data, the at least one processor (204) is configured to:
detect an event corresponding to generation of an invoice on the rendered payment page;
identify Hyper Text Markup Language (HTML) tags and attributes associated with the one or more fields based on a pre-configured lookup table in response to the detection; and
extract the invoice data based on the identified HTML tags and attributes associated with the one or more fields.

13. The system (108) as claimed in claim 8, wherein the at least one processor (204) is configured to transmit the invoice data to the payment terminal (112) using one of an HTTP post transmission, a socket-based connection for transmitting an XML packet, or an MQTT message broker transmission.

14. The system (108) as claimed in claim 8, wherein the at least one processor (204) is configured to generate a report of a plurality of customer transactions at a pre-defined time interval.
